(19) United States
(12) Patent Application Publication
(10) Pub. No.: US 2017/0228422 A1
(43) Pub. Date: Aug. 10, 2017

(54) FLEXIBLE TASK SCHEDULER FOR MULTIPLE PARALLEL PROCESSING OF DATABASE DATA

(71) Applicant: Futurewei Technologies, Inc., Plano, TX (US)

(72) Inventors: Li Zhang, San Jose, CA (US); Guogen Zhang, San Jose, CA (US)

(21) Appl. No.: 15/040,747

(22) Filed: Feb. 10, 2016

(51) Int. Cl. G06F 17/30

(52) U.S. Cl. CPC G06F 17/30445; G06F 17/30477; G06F 17/30463

(57) ABSTRACT

A system and method of responding to a database query. A query is received for MPP database data stored on a plurality of processing systems. A total splits number of the database data, each split containing at least a portion of the database, is determined. If the total splits number splits is greater than a splits threshold number, partial task maps are created and streamed to the processing systems after compiling the query. If the total splits number is less than the splits threshold number, a complete task map for all splits is created and output to the plurality of processing systems.

### BACKGROUND

Distributed processing and storage systems provide redundancy and increased computing power using commodity processing hardware. Such a framework allows for the distributed processing of large data sets across clusters of computers using simple programming models. Each machine or server provides local computation and storage, and is designed to detect and handle failures at the application layer, so delivering a highly-available service on top of a cluster of computers, each of which may be prone to failure.

Such systems are particularly useful in processing of large datasets given their power to access portions of the dataset in parallel. One such framework is the Hadoop® software library from the Apache Software foundation. The Hadoop® framework includes a distributed storage component known as the Hadoop Distributed File System (HDFS) and a distributed processing component known as MapReduce. Structured query language (SQL) is a programming language designed for managing data held in a database system. In order to utilize, for example, an SQL database on a plurality of processing systems using the Hadoop® framework, a component known as Hive™ was developed. Hive is an open-source Java project which converts a SQL query to a series of MapReduce jobs which run on standard Hadoop® task trackers. This component uses a metastore (itself a database) to store table schemas, partitions, and locations. The Hive™ data warehouse software facilitates querying and managing large datasets that reside in distributed storage. Hive™ provides a mechanism to project structure onto this data and query the data using a SQL-like language. Hive™ is considered a traditional toolset installed on many installations. Queries performed with Hive™ are usually very slow because of the overhead associated with using MapReduce.

Traditional techniques implementing, for example, SQL databases running on Hadoop-based multiple parallel processing (MPP) systems, can be inefficient. For example, implementing SQL on Hadoop® traditionally comprises translation of an SQL query into series of MapReduce jobs (using, for example, the Hadoop® Hive™ infrastructure). This technique has various limitations, such as limited SQL syntax support and slow spawn-up time for short-running queries.

### SUMMARY

The technology includes a processor-implemented MPP scheduling method. The method includes receiving a query for processing MPP database data, with splits of the MPP database data being stored on a plurality of processing systems and with each processing system including a storage system with at least a split of the MPP database data stored therein. The method also includes determining a total splits number of the MPP database data and if the total splits number is greater than a splits threshold number, streaming partial task maps to the processing system by: creating a partial task map including a task set for the plurality of processing systems, the task set being a predetermined number of tasks which is less than all tasks needed to access the MPP database data to respond to the query, outputting the partial task map to each processing system of the plurality of processing systems upon creation of the partial task map, and repeating said creating and outputting to create and output a sequence of partial task maps. Each partial task map has tasks for different splits of the MPP database data, and the repeating continues until all tasks accessing all MPP database data needed to respond to the query are included in at least one partial task map.

In another embodiment, the technology comprises a non-transitory computer readable medium storing computer instructions to query MPP database data stored in a data structure spanning a plurality of processing devices. The instructions when executed by one or more processors cause the one or more processors to perform the steps of: determining a total splits number of MPP database data in the data structure, each split containing at least a portion of the MPP database data; creating a successive plurality of task maps if the total splits number is greater than a splits threshold number; and outputting each of the successive plurality of task maps to each of the plurality of processing devices upon creation of each of the successive plurality of task maps. Each task map contains a predetermined number of instructions to the plurality of processing devices to access at least one split of MPP database data to respond to a query. The instructions when executed by one or more processors cause the one or more processors to create and output the successive plurality of task maps until instructions to access all MPP database data to respond to the query are included in at least one task map. Each of the successive plurality of task maps has instructions to read different splits of the MPP database data.

In another embodiment, the technology comprises a multiple parallel processing (MPP) system, including: a plurality of MPP processing devices, each MPP processing device including a non-transitory memory storage including instructions and one or more processors in communication with the memory. The one or more processors on one of the MPP processing devices execute the instructions to receive a query for processing MPP database data, portions of the MPP database data being stored on the plurality of processing devices. The one or more processors on one of the MPP processing devices execute the instructions to retrieve a total splits number, each split including a portion of the MPP database data. If the total splits number is greater than a splits threshold number, the one or more processors on the one of the MPP processing devices execute the instructions to create a partial task map including a predetermined number of instructions for the plurality of processing devices, the instructions to access at least one split of MPP database data to respond to the query. The one or more processors on one of the MPP processing devices execute the instructions to output the partial task map to each processing device of the plurality of processing devices upon creation of the partial task map. The one or more processors on one of the MPP processing devices execute the instructions to repeat said creating and outputting to create and output a sequence of partial task maps, with each partial task map having tasks for different splits of the MPP database data, and continue to repeat creating and outputting until instructions for all splits of the MPP database data are included in at least one partial task map.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts database data as a table file divided into multiple splits as HDFS files.

FIG. 2 is depicts the functional and structural components of an exemplary system suitable for storing the database data illustrated in FIG. 1.

FIG. 3 illustrates functional and structural components suitable for implementing the present technology.

FIG. 4 is a flowchart illustrating a process performed by a scheduler in accordance with the present technology.

FIG. 5A is a flowchart illustrating one embodiment for implementing batch and partial task distribution, and the respective tasks performed by a data node upon receiving the task lists.

FIG. 5B is a flowchart of a process occurring on data nodes of an MPP system when a batch task map is received.

FIG. 6 is a flowchart illustrating creation of a complete or partial task map.

FIG. 7 is an exemplary processing device.

### DETAILED DESCRIPTION

Technology is disclosed to provide improved database query performance in a multiple parallel processing (MPP) system, and in particular a MPP database (MPPDB) system running in a Hadoop® HDFS environment. The MPP system includes processing hardware and an underlying software framework, wherein the MPP system can be implemented on multiple types of processing hardware. An MPPDB system utilizes the MPP system to implement database storage and database processing on the MPP system. The technology in some examples is implemented in an MPP system supporting a Hadoop® MPPDB system on HDFS. The technology in some examples is described with respect to use of an SQL database and an SQL query. However, the technology can be implemented on other systems and for other database protocols or database languages.

Various existing implementations attempt to improve query performance for database queries against database data stored in a Hadoop® HDFS environment. Generally, database data is stored in the form of tables, with table portions or “splits” stored in different storage locations throughout the environment. As used herein, the term “splits” refers to portions of database data that have been divided into smaller files for storage in an MPP system. Traditional implementations of SQL on Hadoop® use some form job scheduling based on a translation of the SQL query into series of MapReduce jobs. MapReduce is known to be slow and inefficient in these implementations. Existing implementations of SQL on Hadoop® all share similar scheduler logic for SQL on Hadoop® task assignments. These scheduler designs do not scale well. When there are a large number of table splits (HDFS files) for a large database data table, the scheduler itself becomes a bottleneck. The scheduling operation takes time, and all MPP data nodes in the environment which store table portions must wait for the scheduler to finish processing all files in the database data before they begin to work on reading the files. In addition, the size of a MapReduce task map is linearly proportional to the size of a database data file, and thus large database data tables generate large task maps. Distributing a number of such large task maps at the same time may cause network congestion. In the context of this disclosure, database data refers to MPP database data, meaning data stored in an MPP environment.

The present technology presents a solution for an MPP database to access database data in a HDFS environment without using the MapReduce framework. The technology uses a flexible, hybrid scheduler to instruct MPP data nodes to process database data table portions efficiently based on data locality and data node workloads.

The scheduler selects between operating in a task “streaming” mode or a “batch” mode based on the size and number of splits of the database data being accessed. In streaming mode, portions of the tasks needed to execute a query of a large amount of database data are captured in partial task maps, and streamed to MPP processors in small batches. This enables the query processing to start even though not all tasks have been created or delivered to processing nodes, and continues streaming these small, partial task maps while still creating other, subsequent partial task maps. This streaming mode generates these partial task maps during query execution, rather than during compile time. In streaming mode, scheduling can be done without affecting task operation and without affecting communications bandwidth. By breaking the scheduling down into smaller batches and sending out small scheduling assignments to various processing nodes, the processing nodes begin processing even as the scheduler continues to generate other small scheduling portions and stream them out to the processing nodes. Thus, the processing nodes can be kept continuously busy without needing to generate a large task schedule and without needing to send out a large task schedule to various processing nodes. This allows processing to begin earlier than in the case when all processing nodes receive the one large task file. In batch mode, used for smaller database data queries, a complete batch file is used and generated at compile time. The technology selects between using each mode based on the size of database data being accessed.

The flexible, hybrid scheduler retrieves database data split information directly from the HDFS NameNode, allowing the scheduler to determine the block location of each table portion directly and to assign the best possible MPP data node to read a database data portion in response to a database query. The flexible, hybrid scheduler evenly distributes work on the splits to available MPP data nodes.

The technology improves the performance of a Hadoop® MPPDB system on HDFS when receiving a database query, where the database data is divided into multiple splits for storage on a plurality of processing systems. The technology determines a total splits number of the database and creates a task instruction file or task map for either the batch mode or for streaming mode, based on the number of splits of the database. If the total splits number is greater than a splits threshold number, a sequence of partial task maps (with each partial task map in the sequence including a tasks set for a subset of splits) is created. The sequence of partial task maps are output to processing systems acting as data nodes upon creation of each partial task map. In this streaming mode, task map creation begins upon receipt of the query and after compiling the database query. Conversely, if the database is small and/or the total splits number is smaller than the splits threshold number, then a single complete task map for all splits in the database can be created for all splits and distributed to the target processing systems. In this latter batch mode, task map creation occurs at compile time.

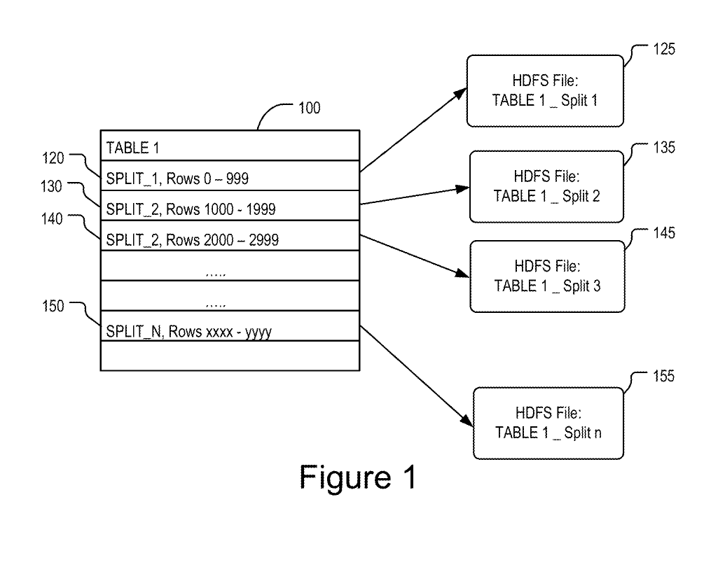

FIG. 1 illustrates how database data 100 in the form of a table file, may be divided into multiple portions for storage on multiple data nodes. Database data 100 includes data in a table data structure (TABLE1) having a plurality of rows and (possibly) data separators in each row. In an MPP system, database data 100 may be divided into portions or splits (120, 130, 140, 150) which can then be stored in different physical and logical locations. Each split may have one or more replicas. In FIG. 1, four splits are illustrated at splits 120, 130, 140, 150, with each split comprising a set number of rows out of a total number of rows in the database data 100. How the splits are determined and where they are stored in an MPP system is dependent on the nature of the storing application utilizing the MPP system. In the embodiment of FIG. 1, the set number of rows illustrated is 1000. Each split 120, 130, 140, 150 may then be stored in a different file storage file 125, 135, 145, 155. Each storage file 125, 135, 145, 155 may thereafter be replicated and distributed to any number of processing systems. In the embodiment of FIG. 1, the files are illustrated as HDFS files that have been divided from the single table. It should be understood that there may be any number of files/tables and any number of splits for each table, each split containing any number of various rows or divisions.

It should be understood that database data may have many representations in an MPP system. In a Hadoop® system, for example, a standard and commonly used Hadoop® table representation is a Hive™ table. A Hive™ table generally comprises HDFS directories where the directory name is the table name, and HDFS files represent the table contents in a specific file format (such as ORC, CSV, etc.). The data in the table may be sliced into multiple splits before writing to HDFS, and each split is a HDFS file which represents part of the table. The number of table splits is controlled by the tool or application used to load the data. The present technology addresses how a MPPDB system reads those splits out from a Hadoop® distributed file system. Other forms of database data and other types of databases which may be supported on an MPP system may be utilized in accordance with the present technology.

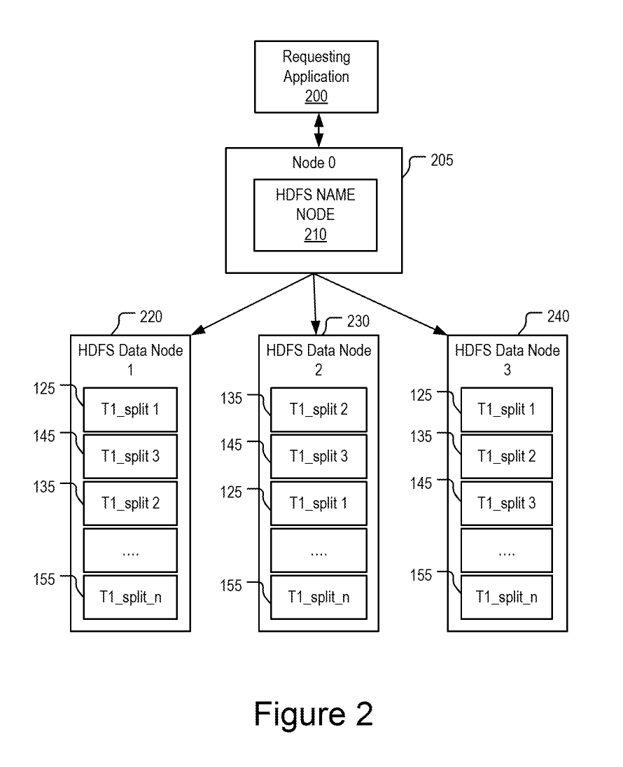

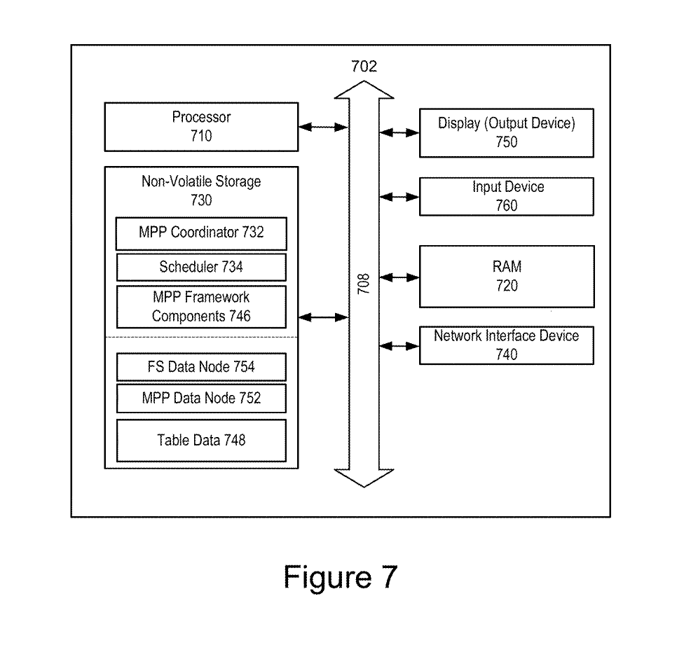

FIG. 2 illustrates one example of how a database data 100 may be stored on various processing system nodes 220, 230, 240. In FIG. 2, four processing system nodes 205, 220, 230, 240 are illustrated. An exemplary processing system is illustrated in FIG. 7 herein. Each processing system node 220, 230, 240 is illustrated as storing splits in files 125, 135, 145, 155 of database data 100 thereon. Each data node may comprise a physical or logical entity. Each physical processing system may include multiple data nodes, and each data node may be spread across multiple processing systems. For example, the configuration of MPPDB data node may be slightly different than Hadoop® HDFS data node. In a MPPDB environment, one host machine may have one or multiple MPPDB data nodes according to the CPU capacity, while in a common Hadoop® HDFS cluster, one host machine usually only has one HDFS data node.

Processing system node 205 houses the name node for the MPP system. In one embodiment where the MPP system is implemented as a Hadoop® cluster, the Hadoop® NameNode 210 keeps a directory tree of all files in the file system, and tracks where, across the cluster, all given file data is kept. A requesting application 200 communicates with the NameNode 210 whenever it needs to locate a file, or when the application needs to manipulate (add/copy/move/delete) a file. The NameNode 210 returns a list of relevant data nodes where the data is stored. In the presently described embodiment, the requesting application 200 is a database application seeking to access data from a database data 100. Hence, a requesting application may run an SQL query against data in the processing system nodes 220, 230, 240 by seeking access to such data via that NameNode 210. Other components of an MPP database system can be included, but are not illustrated in FIG. 2. In the embodiment of FIG. 2, it will be recognized that each node may connected to a high speed network, allowing the nodes to communicate with the name node and other nodes in the system.

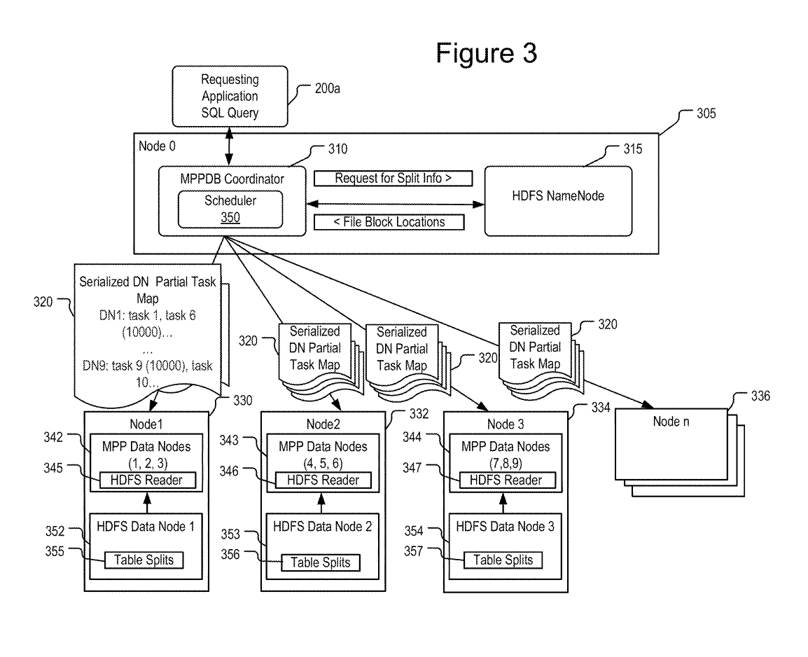

FIG. 3 illustrates components of the present technology along with a representation of communication between the components in one mode. The present technology bypasses the MapReduce framework of orchestrating the task assignments, and provides the MPPDB system with a mechanism for determining where all the table splits (i.e. HDFS files) are stored, how many replicas one split has, which HDFS data node containing the split is collocated with the MPPDB data node, and how to balance the tasks among all the MPPDB data nodes. In addition, the technology provides a capability for accessing very-large datasets, such as a large table with millions or trillions of splits. FIG. 3 illustrates the overall architecture of the scheduler 350 which resides in a typical MPPDB system. The MPPDB system is optionally collocated within a Hadoop® HDFS cluster.

As illustrated in FIG. 3, a MPPDB includes an MPPDB coordinator 310 and MPP data nodes 342, 343, 344. An instance of MPPDB coordinator 310 is provided on processing Node0 305 and instances of MPP data nodes 342, 343, 344 are provided on physical processing system node 330, node 332 and node 334, as well as any number of additional processing system nodes 336 each having a similar configuration to nodes 330, 332, 334. In the example of FIG. 3, each node may comprise a processing system as illustrated in FIG. 7, though it will be recognized that any number of suitable processing systems may be utilized to implement the physical processing system nodes 330, 332, 334, 336. Again, it will be recognized that each of the processing system nodes 330, 332, 334, 336 may be connected to a high speed network, allowing the nodes to communicate with other nodes in the system using standard networking protocols.

In FIG. 3, the MPPDB coordinator 310 is collocated on a processing node (Node0 305) along with the HDFS NameNode 315. While not required for the scheduler operation, such colocation may achieve better overall system performance than in a case of non-colocation, as use of the scheduler and name nodes on different processing systems would utilize remote protocol calls from scheduler to the name node in order to retrieve the splits information.

In one embodiment, the MPP data nodes 342, 343, 340 and MPPDB coordinator 310 are components of any MPP database system. The HDFS NameNode 315, HDFS data nodes 352, 353, 354 and reader components 345, 346 and 347 are all elements of the MPP system. Each HDFS data node 352, 353, and 354 all physically store the database data splits 355, 356, and 357 identified with respect to FIG. 2 on processing system nodes 330, 332, 334.

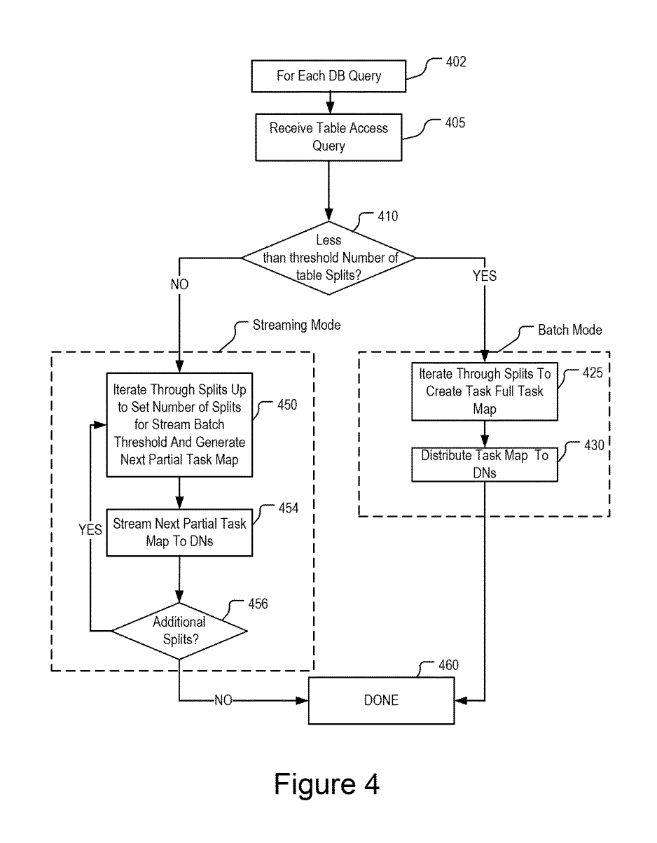

Scheduler 350 performs the functions outlined in the flowcharts of FIGS. 4 through 6. As described below, scheduler 350 operates in either a batch mode or a streaming mode. The streaming mode is illustrated in FIG. 3, as multiple streaming partial task maps 320 are output from the scheduler to each processing node. In batch mode, a single task map is output per query from the scheduler 350 to the processing nodes. In streaming mode, task scheduling is delayed until after compile time, and may be referred to herein as “lazy” scheduling.

In general, as requests for data from the requesting application 200 are received by the MPPDB coordinator 310, the MPPDB coordinator 310 will request split information from the HDFS NameNode 315. For example, when a query comes to the MPPDB coordinator identifying a particular database table to be read, the MPPDB coordinator 310 will determine the directory path through the metadata stored by the MPPDB coordinator 310, and pass the information to the scheduler 350. The scheduler will then query HDFS NameNode 315 to determine the location where the table data physically resides (for example, the HDFS directory), as well as all the split information inside the directory. The split information includes information about how many replicas the split has, along with the HDFS data node location where each replica resides.

The HDFS NameNode will return file block locations to the MPPDB coordinator 310 and scheduler 350. Scheduler 350 will then create a complete task map or a partial task map 320 (depending on the size of the table), identical copies of which are forwarded to each of the processing system nodes 330, 332, and 334. In a batch mode, when the number of splits is less than a splits threshold number (for example, one-thousand splits,) a single task map along with a compiled SQL query is forwarded to each of the processing system nodes 330, 332, 334, 336. In a streaming mode, when the number of splits is greater than the splits threshold number (once again, for example, one-thousand), the scheduler 350 will create partial task maps and will send identical copies of each partial task map 322 each of the processing system nodes 330, 332, 334. Each partial task map will include for example, a sub-set of all read tasks (a partial read tasks amount) needed to respond to the query. The partial read tasks amount may be set by as a predetermined number of splits selected based on how large each partial task map should be given design considerations of the network connecting the MPP systems. The total number of splits needed to respond to the query is referred to herein as the total splits number. The partial read tasks amount may be less than the total splits number of the database data needed to respond to the query, and may be the same as or different than the splits threshold number utilized to determine when to enter streaming mode or batch mode. Each partial task map received by the processing system nodes 330, 332, 334, is read and executed by a HDFS reader to acquire data from a corresponding HDFS data node to access table data in the table splits, allowing the MPP data nodes to return the results of the SQL query to the MPPDB coordinator 310. The MPPDB coordinator 310 is operable to compile, optimize, and stream the queries to the processing system nodes 330, 332, 334.

FIG. 4 illustrates a first method according to the present technology. The method of FIG. 4 may be performed by the scheduler 350 illustrated in FIG. 3, for example. At 402, for each database query, a determination of table access information at 405 is performed. As noted above, table access information returns split information from the MPPDB coordinator 310 and the HDFS NameNode 315. The MPP coordinator metastore includes information on the number of splits from a specific database data table, and the NameNode includes information on the how many replicas each split has, along with the HDFS data node location where each replica resides.

At 410, a determination is made as to whether the number of splits (the total splits number) in the database data is greater than a splits threshold number. If so, then the streaming mode (steps 450, 454 and 456) is performed. If total splits number is less than a splits threshold number, then batch mode (steps 425 and 430) is performed.

In batch mode, at 425, the scheduler iterates through the number of splits for the database data and creates a complete task map containing read tasks for all splits needed to answer the query. The task maps contain a list of tasks identifying which MPP data nodes are to read which table splits. At 430, the task map is distributed to all nodes in the MPP system. As explained below, task map creation occurs at compile time and a query plan and task map may thereafter be distributed to all processing devices in the cluster.

In streaming mode, tasks instructing a read of only a partial number (a fraction of the total splits number) are sent in each partial task map. In streaming mode, at 450, the method iterates through the splits up to a set number of splits and when the set number of splits is reached, a partial task map is created and output to the nodes in the MPP system at 454. If there are additional splits in the database data at 456, the method continues iterating and generating partial task maps at 450 until all the splits in the database data are addressed and the method completes at 460.

The scheduling process of FIG. 4 is embedded in the scheduler 350 of the MPPDB system, in some examples, and is performed once per query. Each task map provides an instruction for each a data node as to which split tasks are assigned to each MPPDB data node. In streaming mode, the map structure is streamed into a block of information and distributed to all MPPDB data nodes to be further processed. Once each MPPDB data node receives the task map, each data node will look for its ID in the task map, access its task list, and scan the database data splits assigned to it.

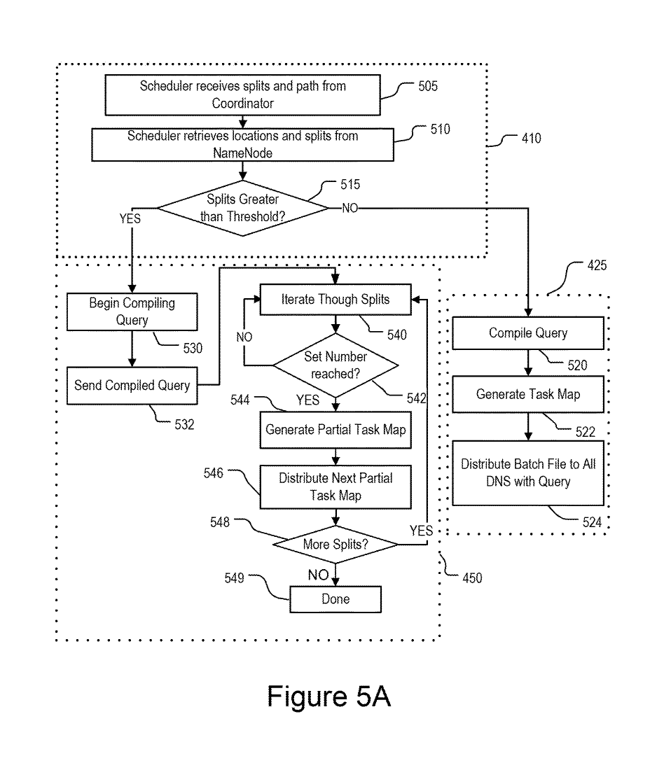

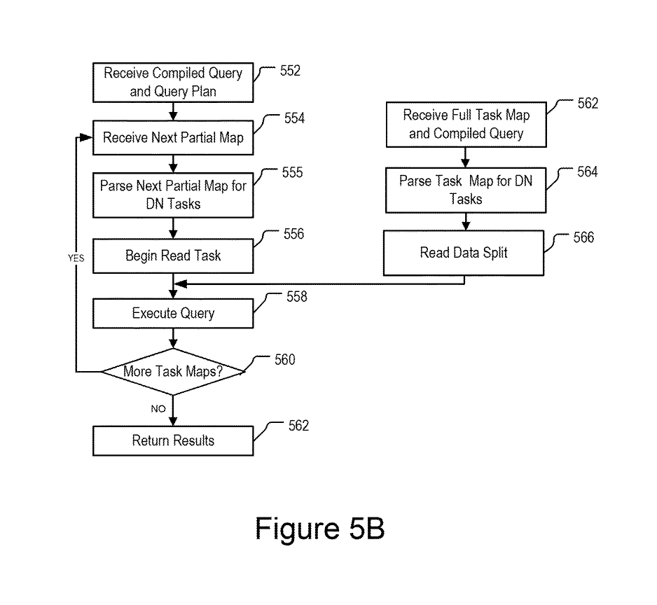

FIG. 5A illustrates steps 410, 425 and 450 in further detail. As explained in FIG. 5A, the choice between using batch mode and streaming mode depends on a splits threshold number. If the number of splits of database data exceeds a splits threshold number, streaming mode is used. Otherwise, batch mode is used. In addition, in batch mode, the scheduling process is done during query compiling time, and the full batch task map will be delivered to all MPPDB data nodes as part of the query plan. In streaming mode, in order to improve performance, scheduling is delayed until query execution time, while the partial task maps are streamed down to the MPPDB data nodes while the scheduler continuously schedules the rest of the read tasks. This technique may be referred to herein as “lazy” scheduling.

In order to determine the number of splits in database data for a particular query, at 505 the scheduler communicates with the MPPDB coordinator 310 to retrieve the number of splits and the directory path from MPPDB coordinator 310. At 510, the location (for example, a HDFS directory) where the database data physically resides, as well as all the split information inside the directory, is retrieved from the HDFS NameNode 315. As noted above, database data 100 may have many representations in an MPP system. In a Hadoop® embodiment, when a query comes to the MPPDB to read a particular Hadoop® database data table, the coordinator will determine HDFS directory path through the table metadata in its metastore, and pass the information to the scheduler. The scheduler will then query HDFS NameNode at 510 to find out the HDFS directory where the database data table physically resides, as well as all the split information inside the directory. The split information includes the how many replicas the split has, along with the HDFS data node location where each replica resides.

At 515 a determination is made as to whether the number of splits is greater than a splits threshold number. The splits threshold number may be less than the total splits number. In one embodiment, the splits threshold number is set at 1000 splits, for example. The size of the split threshold at 515 is generally set to remain small to avoid having the scheduler turn into a bottleneck if the table to be accessed is very large. (This may be the case in a Hadoop® embodiment where tables on the order of terabytes or petabytes are encountered.) In batch mode, the scheduling computation happens at compile time, and thus all MPPDB data nodes wait till they receive the final complete task map before they can actually read the data.

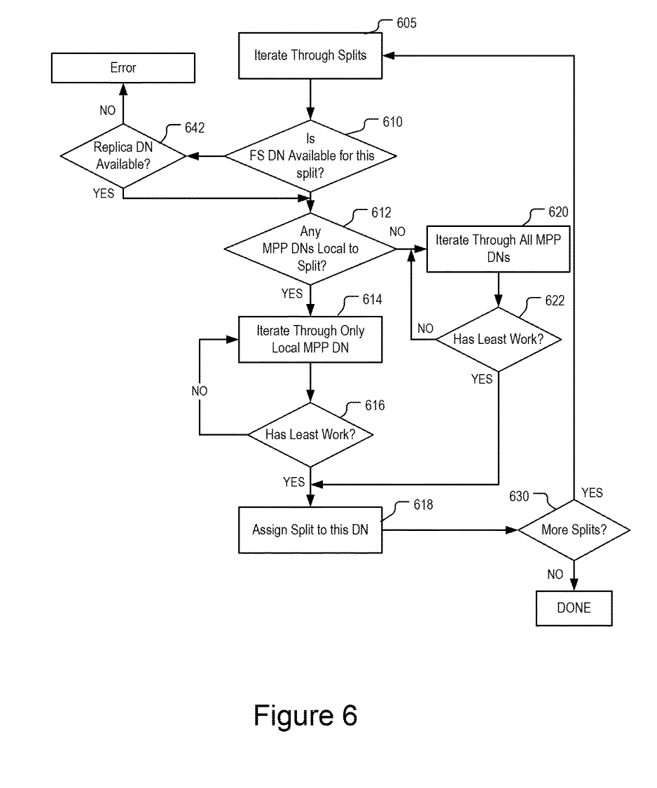

If the number of splits to be accessed to respond to the query is less than the splits threshold number, then step 425 is performed. Step 425 begins compiling the query at 520. In general, the MPP coordinator will compile and optimize the query for execution on each of the MPP nodes in the system. At 522, a complete task map is created. A method for creating the task map is illustrated in FIG. 6. In general, once the scheduler obtains the table splits location information from HDFS name node, it iterates through each table split, and determines which MPPDB data node is the best “worker” to read the split or splits. In a Hadoop® embodiment, the configuration of a MPPDB data node is slightly different than Hadoop® HDFS data node. In a MPPDB environment, one host machine may have one or multiple MPPDB data nodes according to the CPU capacity, while in a common Hadoop® HDFS cluster, one host machine usually only has one HDFS data node. The configuration difference creates more complexity for the scheduler to handle. For example, one table split in HDFS may have three replicas on three different host machines, and each machine may have multiple MPPDB data nodes setup. If four MPPDB data nodes exist, for example, then 3*4=12 MPPDB data nodes are considered “local” to this table split. As such, the scheduler determines which one of the twelve data nodes in this example is the best to handle the split, and this is done through series of condition checks as illustrated in FIG. 6.

Once the task map is complete, the task map and compiled query are distributed to the MPP nodes at 524.

Returning to step 515, if the number of splits to be accessed to respond to the query is greater than the splits threshold number, then the streaming mode begins at 450. At 540, the scheduling process begins before or in parallel with compiling of the query at 530. Since, in streaming mode, the scheduler does not wait for the compiling of the query to complete, the scheduler is no longer a bottleneck on large query jobs. Once completed, the compiled query is output at 532 and the MPPDB data nodes will await the task maps to begin executing the query.

At 540, the scheduler iterates through the splits until a predetermined number of splits is reached at 542. Once reached, a partial task map is created at 544. The method of FIG. 6, described below, for creating the partial task map is essentially the same as the step 522 for creating a complete task map except that a limited (predetermined) number of splits are tasked, after which the partial task map is distributed. Once each partial task map is completed and generated at 544, it is distributed at 546. A determination is made as to whether additional splits exist at 548 and if additional splits remain at 548, steps 540, 542, 544 and 546 are repeated until the total splits number for the table in the query to be accessed is reached and the method completes at 549.

FIG. 5B illustrates the process occurring on a MPPDB node upon receipt of the full or partial task map. Steps 562, 564 and 566 represent execution of a complete task map by the MPPDB data node. At 562, a complete task map is received. At 563, the data node will parse the task map for those tasks assigned to it and at 566, the data node will read each of the splits assigned in the task map. At 558, the query submitted against the data is executed and query results are returned to the coordinator at 562 (step 560 will return “no” and a complete task map is received at 562).

Steps 552, 554, 555, and 556 illustrate the processing of a partial task map. At 552, when the streaming mode is enabled, the data node will receive the compiled query and await the read task instructions in the partial task maps. The data node will receive a next partial task map at 554 and parse the partial map for tasks assigned to the data node at 555. At 556, the data node will begin reading the split data, executing the query at 558 on each set of splits for that data node in each partial task map. At 558, if there are additional splits in the database data, the process continues at 540 until the query is executed and finishes retrieving all data. The results of the query are returned at 560. The technology thus improves the speed at which the output results of the initial query are returned in an MPP system.

FIG. 6 illustrates a method for generating a full or partial task map. For a partial task map, the method of FIG. 6 will repeat for each partial task map. At 605, the system will iterate through a number of splits. When in batch mode, at 605 the scheduler iterates through the total splits number, while in streaming mode, at 605 the scheduler iterates through the predetermined number of splits. At 610, a determination is made as to whether a data node is available for this split. At 610, the scheduler will go through each database data split and find all the available host names and IP addresses of the hosting machines, including the replicas. In a Hadoop® system, HDFS generally has three or more replicas of the file scattered around different HDFS data nodes, and some of them may not be available for use. The method takes account of this behavior and only counts the HDFS data nodes that are available to use, with the data node availability information being available from the HDFS Name Node.

If no data nodes are available at 610, then a determination is made at 642 as to whether a replica data node is available at 642. If no data node or replica data node is available, an error is output.

If data nodes are available at 610, then the method will determine at 612 whether the MPP data nodes are local to the split. In other words, a determination is made as to whether the data resides on a same physical processing system as the split. Step 612 scans through all the MPPDB data nodes and finds all available data nodes which are local to the split (having the same hostname/IP as the split), storing them as the “available candidates” for the next step.

From the “available candidates” obtained from step 612, at 614 the method iterates through local MPP data nodes and at 616 finds the first data node with no task assigned. If such a local node is found at 616, the task is assigned to it at 618. If all candidates have tasks assigned, then step 616 finds the data node with least tasks assigned and assigns the split to it. This process can be further optimized to deal with large amount of available worker nodes by using a data structure similar to a “LRU” cache, which puts the worker node with a lighter load at the front of the queue and repositions the heavy processing load to the rear of the cache each time a split is assigned to a worker processing node.

If none of the MPPDB data nodes are local to the split at 612, then the method will choose one remote MPPDB data node with least tasks assigned and append the split to the task map for that node. The method will iterate through all MPPDB data nodes at 620 to determine which data node has the least work at 622. The method continues at 630 until all tasks are assigned. Assigning non-local tasks is not an optimal situation because a remote read is almost always slower than a local read, but the method has to deal with this situation when MPPDB data nodes are not deployed on every HDFS data nodes.

The output of the method of FIG. 6 is thus a list of tasks (full or partial) and associated data nodes assigned to read those tasks.

The method of FIG. 6 ensures all the table splits are processed by MPPDB data nodes in a local read preferred fashion, and all MPPDB data nodes get a relatively even amount of tasks assigned. This is all done during query compile time in streaming mode. Once the partial task map is done, it is serialized and distributed onto all MPPDB data nodes as part of the query plan waiting to be processed.

One alternative or additional solution to the issue of schedule bottleneck is for the scheduler to compress the data node-task map before sending it out. This may be used with either the batch mode or the streaming mode. The streaming mode implements so called “lazy” scheduling in which the scheduling computation is delayed from compile time to execution time. The MPPDB coordinator delays calling the scheduler to do the task map creation, but compiles the query and constructs a query plan. Once the query plan is delivered to the MPPDB data nodes, the MPPDB data nodes signal the scheduler that they are ready to read the data. The scheduler will then start to compute the task map, and enter the task streaming stage.

The technology provides a system in which the MPPDB data nodes need not wait until the scheduler finishes all the scheduling work before reading the data. For example, once the scheduler finishes the first 1000 splits, it sends the task map to all MPPDB data nodes to process, while continuing to schedule the rest of splits in parallel, streaming the batches out every 1000 splits, for example. Since the number of MPPDB data nodes is fixed, each batch can be configured as a columnar data structure, which is essentially an N by 1000 2-dimensional array with N being the number of MPPDB data nodes, where each column of the matrix contains the tasks assigned to the MPPDB data node. In MPPDB architecture, the streaming usually happens between data nodes, but in this case, the streaming operation between CN and data nodes can be utilized for the data node task map.

FIG. 7 is a computing system 702 suitable for use in implementing the present technology. The computing system 702 may include, for example, a processor 710, random access memory (RAM) 720, non-volatile storage 730, a display unit (output device) 750, an input device 760, and a network interface device 740. The components are coupled to a bus 708. In certain embodiments, the computing system 702 may be embedded into a personal computer, mobile computer, mobile phone, tablet, or other suitable processing device.

Illustrated in non-volatile storage 730 are functional components which may be implemented by instructions operable to cause processor 710 to implement one or more of the processes described below. While illustrated as part of non-volatile storage 730, such instructions may be operate to cause the processor 710 to perform various processes described herein using any one or more of the hardware components illustrated in FIG. 7. These functional components include a virtual machine manager and a VNF.

Non-volatile storage 730 may comprise any combination of one or more non-volatile computer readable media. The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

The computer system 702 can include a set of instructions that can be executed to cause computer system 702 to perform any one or more of the methods or computer based functions disclosed herein. Computer program code for carrying out operations for aspects of the present disclosure may be written in any combination of one or more programming languages, including an object oriented programming language conventional procedural programming languages. The program code may execute entirely on the computer system 702, partly on the computer system 702, as a stand-alone software package, partly on the computer system 702 and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service.

The processor 710 is configured to execute software instructions in order to perform functions as described in the various embodiments herein. The processor 710 may be a general purpose processor or may be part of an application specific integrated circuit (ASIC). The processor 710 may also be a microprocessor, a microcomputer, a processor chip, a controller, a microcontroller, a digital signal processor (DSP), a state machine, or a programmable logic device. The processor 710 may also be a logical circuit, including a programmable gate array (PGA) such as a field programmable gate array (FPGA), or another type of circuit that includes discrete gate and/or transistor logic. The processor 710 may be a central processing unit (CPU), a graphics processing unit (GPU), or both. Additionally, any processor described herein may include multiple processors, parallel processors, or both. Multiple processors may be included in, or coupled to, a single device or multiple devices.

Illustrated in the non-volatile storage 730 are components for implementing a name node, including a MPP Coordinator code component 732, scheduler code component 734, and MPP Framework component 746. Also illustrated are components for implementing a data node, including FS data node code component 754, MPP data node code component 752, and database data 748. In general, the name node will not be co-located with a data node and, components 732, 734, and 746 will not reside on the same physical node as components 754, 752, and database data 748. They are thus illustrated in FIG. 7 for convenience only. The code components 732, 734, and 746 may be utilized by the processor to create the MPPDB coordinator 310, scheduler 350, and MPP systems 305 of FIG. 1. The code components 754, 752, and database data 748 may be utilized to create the FS data node, MPP data node and table data of FIG. 1. Each of the components may comprise instructions capable of causing the processor 770 to execute steps to perform the methods discussed herein.

As shown, the computing system 702 may further include a display unit (output device) 750, such as a liquid crystal display (LCD), an organic light emitting diode (OLED), a flat panel display, a solid state display, or a cathode ray tube (CRT). Additionally, the imaging processor may include an input device 760, such as a keyboard/virtual keyboard or touch-sensitive input screen or speech input with speech recognition, and which may include a cursor control device, such as a mouse or touch-sensitive input screen or pad.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The technology advantageously provides a processor-implemented method of responding to a database query, wherein portions of the database are stored on a plurality of processing systems. Each of the processing systems include a storage system with at least a portion of the database stored therein. The method determines a total splits number of the database, each split containing at least a portion of the data stored in the database. If the number of total splits is greater than a threshold number, the method creates creating a partial task map including a set of tasks for the processing systems for a set number of splits. The method outputs the partial task map to the plurality of processing systems upon creation of the partial task map, and repeats creating additional partial task maps to create a sequence of partial task maps. Each partial map has tasks for different splits of the data up to the set number of splits until all splits of the total splits number are included in at least one partial task map. If the number of splits is less than a threshold number, the method creates a complete task map including the total splits number and outputs the complete task map with the total splits number to the plurality of processing systems. A query result is provided by executing the query against each of the splits based on the set of tasks for the processing system.

The technology thus provides a system and method of improving the performance of an MPPDB system when receiving a query for a database where the database itself is split into multiple parts on multiple processing systems. The technology determines a total splits number of the database and creates a read task instruction file or task map using either a complete task map, batch mode or in multiple, partial task map, streaming mode based on the number of splits of the database. If the number of total splits is greater than a threshold number, a partial task map including a set of tasks for a set number of splits is created. The partial task maps are created for the set number of splits sequentially and are output to the processing systems upon creation of each partial task map. In this streaming mode, task map creation begins upon receipt of the query and after compiling the database query. If the database is small and the number of splits is smaller than the threshold number, then a single complete task map for all splits in the database is created and distributed. In this latter batch mode, task map creation occurs at compile time.

In a Hadoop® environment, the technology bypasses the Hadoop® MapReduce framework, directly accessing file metastore information from a Hadoop® name node, and assigns table splits to their local MPPDB data nodes. The technology provides for evenly distributing tasks among MPPDB data nodes per query, thereby improving performance and balancing the processing load. Lazy scheduling and task streaming of partial task batches enables efficiency between the scheduling computation and data reading processes for large scale data sets.

In accordance with the above advantages, the technology includes the MPPDB coordinator 310 for receiving a query for database data, splits of the database are stored on a plurality of processing system nodes 330, 332, 334, with each processing system comprising a storage system with at least a portion of the database stored therein. Also included is a scheduler 350 for determining a total splits number of the database, with each split containing at least a portion of the database data. If the total splits number is greater than a threshold number, the scheduler 350 operates to create a partial task map including tasks for a predetermined number of splits for the processing systems, outputs the partial task map to the plurality of processing systems upon creation of the partial task map, and repeatedly creates a sequence of partial task maps having tasks for different splits of the database data up to the predetermined number of splits until all splits of the total splits number are included in at least one partial task map. If the number of splits is less than a splits threshold number, the scheduler 350 operates to create a complete task map including the total splits number and outputting the complete task map with the total splits number to the plurality of processing systems.

The technology provides a number of advantages over existing solutions for SQL on Hadoop®. The technology provides parallelized scheduling of MPP DN task jobs, reducing the potential bottlenecks which result from task scheduling computation. The scheduler provides load balancing by processing data locally stored on a data node, if possible, and balancing task performance among the data nodes by intelligently choosing the best data node to handle the task

The technology provides MPPDB query speed improvements by using hybrid operational modes, choosing between a batch task assignment mode and streaming mode. In streaming mode, “lazy” scheduling is performed by performing scheduling before compiling the database query. The scheduler accesses database data split information directly from the HDFS name node to provide improved data consistency.

This differs significantly from the prior art which uses task scheduling techniques that do not scale well to large data sets. The scheduling combined with task streaming mechanism in this invention addresses the pain point by breaking the pipeline and parallelizing the scheduling work.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A processor-implemented MPP scheduling method, comprising:
receiving a query for processing MPP database data, with splits of the MPP database data being stored on a plurality of processing systems and with each processing system comprising a storage system with at least a split of the MPP database data stored therein;
determining a total splits number of the MPP database data; and
if the total splits number is greater than a splits threshold number,
creating a partial task map including a task set for the plurality of processing systems, the task set being a predetermined number of tasks which is less than all tasks needed to access the MPP database data to respond to the query,
outputting the partial task map to each processing system of the plurality of processing systems upon creation of the partial task map, and
repeating said creating and outputting to create and output a sequence of partial task maps, with each partial task map having tasks for different splits of the MPP database data, the repeating continuing until all tasks accessing all MPP database data needed to respond to the query is included in at least one partial task map.

2. The method of claim 1 wherein if total splits number is less than the splits threshold number, creating a complete task map when compiling the query, the complete task map including tasks for reading all MPP database data needed to respond to the query, and outputting the complete task map to the plurality of processing systems.

3. The method of claim 1 wherein if the total splits number is greater than the splits threshold number, further including compiling the query to provide a compiled query prior to creating the partial task map, and outputting the compiled query to each processing system of the plurality of processing systems prior to creating the partial task map.

4. The method of claim 1 wherein the creating generates a next partial task map in the sequence of partial task maps while at least one of the plurality of processing systems begins processing the query.

5. The method of claim 1 wherein the determining includes reading an indicator from a HDFS NameNode, with the indicator characterizing the total splits number of the MPP database data.

6. The method of claim 1 further including determining a HDFS data node and a block location where each split of MPP database data is stored by accessing a HDFS NameNode.

7. The method of claim 1 wherein the processing systems include one or more HDFS data nodes and the creating the partial task map includes assigning the task to one of the one or more HDFS data nodes by determining an available one of the one or more HDFS data nodes locally storing MPP database data associated with the task, and assigning the task to one of the plurality of processing systems having the available one of the one or more HDFS data nodes storing MPP database data associated with the task.

8. The method of claim 7 wherein the assigning the task further comprises determining that multiple available HDFS data nodes are locally storing MPP database data associated with the task, and assigning the task to one of the plurality of processing systems having the available one of the one or more HDFS data nodes storing MPP database data associated with the task and having a least processor work load.

9. The method of claim 7 wherein the assigning the task further comprises determining that no available HDFS data nodes are locally storing MPP database data associated with the task, and assigning the task to one of the plurality of processing systems having the available one of the one or more HDFS data nodes accessing MPP database data associated with the task via a network and having a least processor work load.

10. A non-transitory computer readable medium storing computer instructions to query MPP database data stored in a data structure spanning a plurality of processing devices, that when executed by one or more processors cause the one or more processors to perform the steps of:
determining a total splits number of MPP database data in the data structure, each split containing at least a portion of the MPP database data;
creating a successive plurality of task maps if the total splits number is greater than a splits threshold number, each task map containing a predetermined number of instructions to each of the plurality of processing devices to access at least one split of MPP database data to respond to a query, said creating including creating the successive plurality of task maps until instructions to access all MPP database data to respond to the query are included in at least one task map, each of the successive plurality of task maps having instructions to read different splits of the MPP database data; and
outputting each of the successive plurality of task maps to each of the plurality of processing devices upon creation of each of the successive plurality of task maps.

11. The non-transitory computer readable medium of claim 10 further including instructions that when executed by one or more processors cause the one or more processors to create a complete task map including instructions to read all splits in the total splits number when the total splits number is less than the splits threshold number, and to output the complete task map to the plurality of processing devices.

12. The non-transitory computer readable medium of claim 11 wherein each of the successive plurality of task maps includes an identical set of instructions for the plurality of processing devices.

13. The non-transitory computer readable medium of claim 12 further including instructions that when executed by one or more processors cause the one or more processors to communicate with a HDFS NameNode, to retrieve the total splits number of the MPP database data, and to determine a HDFS data node and a block location where each split of MPP database data is stored.

14. The non-transitory computer readable medium of claim 13 wherein the instructions further cause the one or more processors to assign a task to one of the plurality of processing devices based on at least the block location of the MPP database data being stored on the one of the plurality of processing devices and balancing a total processing load of the plurality of processing devices.

15. The non-transitory computer readable medium of claim 14 wherein the instructions further cause the one or more processors to compile the query and to output the query to the plurality of processing devices when the total splits number is less than the splits threshold number and prior to creating any of the successive plurality of task maps.

16. The non-transitory computer readable medium of claim 15 wherein the instructions further cause the one or more processors to determine available HDFS data nodes locally storing MPP database data associated with the task, and assign the task to a processing system having an available HDFS data node locally storing MPP database data associated with the task.

17. A multiple parallel processing (MPP) device, comprising:
a plurality of MPP processing device, each MPP processing device comprising a non-transitory memory storage comprising instructions and one or more processors in communication with the memory, wherein the one or more processors on one of the MPP processing devices execute the instructions to:
receive a query for processing MPP database data, portions of the MPP database data being stored on the plurality of processing devices;
retrieve a total splits number, each split including a portion of the MPP database data; and
if the total splits number is greater than a splits threshold number, the one or more processors on the one of the MPP processing devices execute the instructions to:
create a partial task map including a predetermined number of instructions for the plurality of processing devices, the instructions to access at least one split of MPP database data to respond to the query,
output the partial task map to each processing device of the plurality of processing devices upon creation of the partial task map, and
repeat said creating and outputting to create and output a sequence of partial task maps, with each partial task map having tasks for different splits of the MPP database data, and continue to repeat creating and outputting until instructions for all splits of the MPP database data are included in at least one partial task map.

18. The multiple parallel processing system of claim 17 wherein if total splits number is less than the splits threshold number, creating a complete task map when compiling the query, the complete task map including tasks reading all MPP database data for the query, and the one or more processors on the one of the MPP processing devices execute the instructions to output the complete task map to the plurality of processing devices.

19. The multiple parallel processing system of claim 17 wherein if the total splits number is greater than the splits threshold number, the one or more processors on the one of the MPP processing devices execute the instructions to compile the query prior to creating the partial task map, and the one or more processors on the one of the MPP processing devices execute the instructions to output a compiled query to each processing device of the plurality of processing devices prior to creating the partial task map.

20. The multiple parallel processing system of claim 17 wherein the one or more processors on the one of the MPP processing devices execute the instructions to create the partial task map by assigning a task to one of the plurality of processing devices, the one of the plurality processing devices include one or more HDFS data nodes and the assigning comprises determining that multiple available HDFS data nodes are storing MPP database data associated with the task, and the one or more processors on the one of the MPP processing devices execute the instructions to assign the task to one of the plurality processing devices having an available HDFS data node storing MPP database data associated with the task and having a lowest processor work load.
